(19) United States
(12) Patent Application Publication
(10) Pub. No.: US 2016/0033963 A1
(43) Pub. Date: Feb. 4, 2016

(54) REMOTE AUTONOMOUS DRIVING SYSTEM BASED ON HIGH ACCURACY OF LOCALIZATION BY INDOOR INFRASTRUCTURE MAP AND SENSOR AND METHOD THEREOF

(71) Applicant: Electronics and Telecommunications Research Institute, Daejeon (KR)

(72) Inventor: Samyeul NOH, Daejeon (KR)

(21) Appl. No.: 14/814,889

(22) Filed: Jul. 31, 2015

(30) Foreign Application Priority Data
Aug. 1, 2014 (KR) 10-2014-0099065

(51) Int. Cl. G05D 1/00; G05D 1/02; H04L 29/06

(52) U.S. Cl. CPC G05D 1/0022; H04L 67/42; G05D 1/0276

(57) ABSTRACT

Provided is a remote autonomous driving system based on position recognition using an indoor infrastructure map and a sensor device and a method thereof. The server device for remote autonomous driving based on position recognition includes a first network interface unit configured to receive sensing information obtained by a movable infrastructure sensor device sensing a remotely controlled vehicle and transmit a control command for the movable infrastructure sensor device to track the remotely controlled vehicle, a remote controller unit configured to generate a driving route of the remotely controlled vehicle and a driving control command corresponding to the driving route using the sensing information, and a second network interface unit configured to transmit the driving control command to the remotely controlled vehicle.

### CROSS-REFERENCE TO RELATED APPLICATIONS

This application claims priority under 35 U.S.C. §119 to Korean Patent Application No. 10-2014-0099065, filed on Aug. 1, 2014, the disclosure of which is incorporated herein by reference in its entirety.

### TECHNICAL FIELD

The present invention relates to an autonomous driving technique, and more particularly, to a remote autonomous driving system based on position recognition using an indoor infrastructure map and a sensor, and a method thereof.

### BACKGROUND

An autonomous driving system has been mainly applied to vessels and aircrafts. Recently, the autonomous driving system is also applied to vehicles traveling on roads with the aim of self-driving cars.

An autonomous driving system determines a driving behavior and a driving trajectory based on positions of the ego vehicle and nearby other vehicles. For example, the autonomous driving system provides various information, such as a trajectory, road congestion, etc to the user through a monitor, or drives the vehicle by controlling actuators of the system.

In an autonomous driving system, an accuracy of the position recognition is an important element that is directly related to driving reliability and safety. An existing autonomous driving system probabilistically recognizes its position and positions of nearby other vehicles by using local sensors equipped in the ego vehicle.

For example, the vehicle may be automatically driven under a predetermined condition by controlling actuators with computers, software for vehicle control, and several sensors, such as laser scanners, cameras, radars, etc.

Such position recognition based on local sensors should require a vehicle to be equipped with a position recognition sensor and a surrounding environment recognition sensor, which are costly, and thus is difficult to be commercialized because of a practical problem such as cost.

In addition, since only information on the vicinity of the local sensor can be detected, an event occurring in a region outside this sensing range is not recognized, and thus there are limitations in securing safe autonomous driving.

### SUMMARY

Accordingly, the present invention provides a system and method for accurately recognizing a position of the ego vehicle by using an indoor infrastructure map and sensing information provided from an infrastructure sensor, which provides a remote autonomous driving or parking service based on the recognized position.

The purpose of the present invention is not limited to the aforesaid, but other purposes not described herein will be clearly understood by those skilled in the art from descriptions below.

In one general aspect, a server device for remote autonomous driving based on position recognition includes the first network interface unit configured to receive sensing information obtained by a movable infrastructure sensor device sensing a remotely controlled vehicle and transmit a control command for the movable infrastructure sensor device to track the remotely controlled vehicle, a remote controller unit configured to generate a driving route of the remotely controlled vehicle and a driving control command corresponding to the driving route using the sensing information, and the second network interface unit configured to transmit the driving control command to the remotely controlled vehicle.

The remote controller unit may include a vehicle pose recognition unit configured to recognize a pose of the remotely controlled vehicle using the sensing information.

The vehicle pose recognition unit may recognize the position of the remotely controlled vehicle using a relative position coordinate of the infrastructure sensor device included in the sensing information.

The vehicle pose recognition unit may recognize the pose of the remotely controlled vehicle using a rotation angle of the infrastructure sensor with respect to an axis which the infrastructure sensor is fixed to.

The remote controller may further include a map mapping unit configured to map the recognized position and pose of the vehicle on an indoor infrastructure map.

The remote controller may further include a driving route generation unit configured to designate a destination of the remotely controlled vehicle using the indoor infrastructure map, the recognized position and pose information of the vehicle, and information obtained by mapping the recognized position and pose information of the vehicle on the indoor infrastructure map, and generate a driving route from a real-time recognized position of the vehicle to the destination.

The driving control command may include additional information including a vehicle speed and a driving lane in an entire route from departure to destination.

The server device may further include a third network interface unit configured to transmit the information obtained by mapping the recognized position and pose information of the vehicle on the indoor infrastructure map to a user terminal and receive an autonomous driving service request from the user terminal.

The remote controller may search the remotely controlled vehicle corresponding to the autonomous driving service request from the indoor infrastructure map and transmit a control command for the infrastructure sensor device to track the searched remotely controlled vehicle through the first network interface unit.

In another general aspect, a remote autonomous driving method that is performed by a server device for remote autonomous driving based on position recognition includes: registering a remotely controlled vehicle using sensing information obtained by sensing the remotely controlled vehicle; generating a control command for a movable infrastructure sensor device to track the remotely controlled vehicle; and generating a driving route of the remotely controlled vehicle and a driving control command corresponding to the driving route using the sensing information obtained by the infrastructure sensor device tracking and sensing the remotely controlled vehicle.

The generating of a driving route of the remotely controlled vehicle and a driving control command corresponding to the driving route may includes: recognizing the position and pose of the remotely controlled vehicle using the sensing information obtained by the infrastructure sensor device tracking and sensing the remotely controlled vehicle, and mapping the recognized position and pose of the vehicle on an indoor infrastructure map.

The recognizing of the position and pose of the remotely controlled vehicle may include: recognizing the position of the remotely controlled vehicle using a relative position coordinate of the infrastructure sensor device included in the sensing information, and recognizing the pose of the remotely controlled vehicle using a rotation angle of the infrastructure sensor with respect to an axis which the infrastructure sensor is fixed to.

The generating of a driving route of the remotely controlled vehicle and a driving control command corresponding to the driving route may further include: designating a destination of the remotely controlled vehicle using the indoor infrastructure map, the recognized position and pose information of the vehicle, and information obtained by mapping the recognized position and pose information of the vehicle on the indoor infrastructure map, and generating a driving route from a real-time recognized position of the vehicle to the destination.

The driving control command may include additional information including a vehicle speed and a driving lane in an entire route from departure to destination.

The method may further include transmitting the information obtained by mapping the recognized position and pose information of the vehicle on the indoor infrastructure map to a user terminal and receiving an autonomous driving service request from the user terminal.

The receiving of an autonomous driving service request may include searching the remotely controlled vehicle corresponding to the autonomous driving service request from the indoor infrastructure map and generating a control command for the infrastructure sensor device to track the searched remotely controlled vehicle.

Other features and aspects will be apparent from the following detailed description, the drawings, and the claims.

### BRIEF DESCRIPTION OF THE DRAWINGS

FIG. 1 is a block diagram showing a remote autonomous driving system based on position recognition using an indoor infrastructure map and a sensor according to an embodiment of the present invention.

FIG. 2 is an exemplary diagram showing a remote autonomous driving system according to an embodiment of the present invention.

FIG. 3 is a block diagram showing a server device according to an embodiment of the present invention.

FIG. 4 is a detailed block diagram showing a remote controller unit of FIG. 3.

FIG. 5 is an exemplary diagram showing an example in which a position of an autonomous driving vehicle is recognized according to an embodiment of the present invention.

FIG. 6 is an exemplary diagram showing an example in which a position of an autonomous driving vehicle is mapped on an indoor infrastructure map according to an embodiment of the present invention.

FIG. 7 is a flowchart showing operations of a remote autonomous driving system based on position recognition using an indoor infrastructure map and a sensor according to an embodiment of the present invention.

### DETAILED DESCRIPTION OF EMBODIMENTS

Hereinafter, embodiments of the present invention will be described in detail with reference to the accompanying drawings.

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

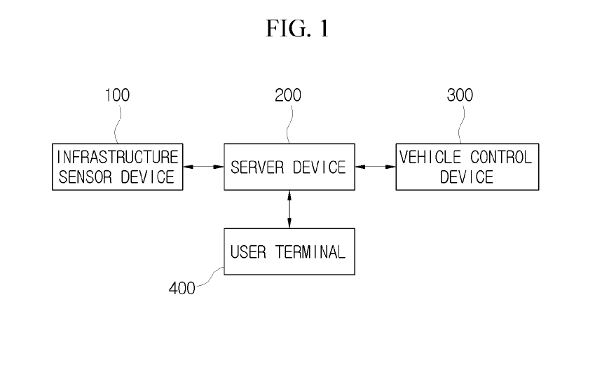

FIG. 1 is a block diagram showing a remote autonomous driving system based on position recognition using an indoor infrastructure map and a sensor according to an embodiment of the present invention.

Referring to FIG. 1, a remote autonomous driving system based on position recognition using an indoor infrastructure map and a sensor according to an embodiment of the present invention (hereinafter, referred to an a remote autonomous driving system) includes an infrastructure sensor device 100, a server device 200, a vehicle control device 300, and a user terminal 400.

The infrastructure sensor device 100 includes a camera, two- or three-dimensional laser scanner, an ultrasonic wave sensor, and so on, and senses any kind of event, obstacle, and nearby vehicle on a trajectory of a remotely controlled vehicle (hereinafter referred to as a vehicle) and transmits the sensing information to the server device 200. Here, the infrastructure sensor device 100 and the server device 200 may perform data communication through a wireless network.

In an embodiment of the present invention, the infrastructure sensor device 100 is installed at a predetermined region in a space such as an underground parking lot of a department store, and there is no limitation on the kind or number of sensor devices installed in a corresponding region. For example, only one camera may be installed in a first region of the underground parking lot, and two cameras and one ultrasonic wave sensor may be installed in a second region. Thus information obtained by sensing the first or second region may be transmitted to the server device 200.

Alternatively, the infrastructure sensor device 100 may be movably installed. For example, the infrastructure sensor device 100 may be designed to be installed on a ceiling of a space such as an underground parking lot of a department store to move freely or designed to move along a route on which a vehicle may be driven. For this, although not shown in FIG. 1, the infrastructure sensor device 100 may include a driving unit for moving the infrastructure sensor device 100.

The above-described movable infrastructure sensor device 100 that is designed to be movable collects information on a vehicle and an environment surrounding the vehicle in real time while tracking a trajectory of the vehicle. The real-time sensing information that is collected by the movable infrastructure sensor device 100 is transmitted to the server device 200 through a wireless network in real time. The server device 100 calculates a position and a pose of the vehicle using the collected sensing information.

The server device 200 controls autonomous driving of the vehicle control device 300 included in the vehicle in cooperation with the infrastructure sensor device 100. Specifically, the server device 200 registers information on a remotely controlled vehicle that requests an autonomous driving service using the sensing information that is transmitted from the infrastructure sensor device 100 and then generate a driving control command corresponding to the driving route.

Furthermore, the server device 200 generates information such as a position and a pose of the vehicle using the sensing information. The server device 200 includes an indoor infrastructure map, and the position and pose information that is generated in real time is mapped on the indoor infrastructure map in real time.

In addition, the server device 200 stores the position and pose information of the vehicle that is generated in real time and the information that is obtained by mapping the information on the indoor infrastructure map and provides the stored information to a terminal 400 of a user who requests an autonomous driving service.

The vehicle control device 300 performs autonomous driving of the vehicle according to the driving control command that is transmitted from the server device 200. For example, the driving control command includes additional information including a vehicle speed and a driving lane on an entire route from departure to destination. Thus vehicle control device 300 performs autonomous driving of a vehicle by driving an actuator of the vehicle to control steering, driving, and braking of the vehicle.

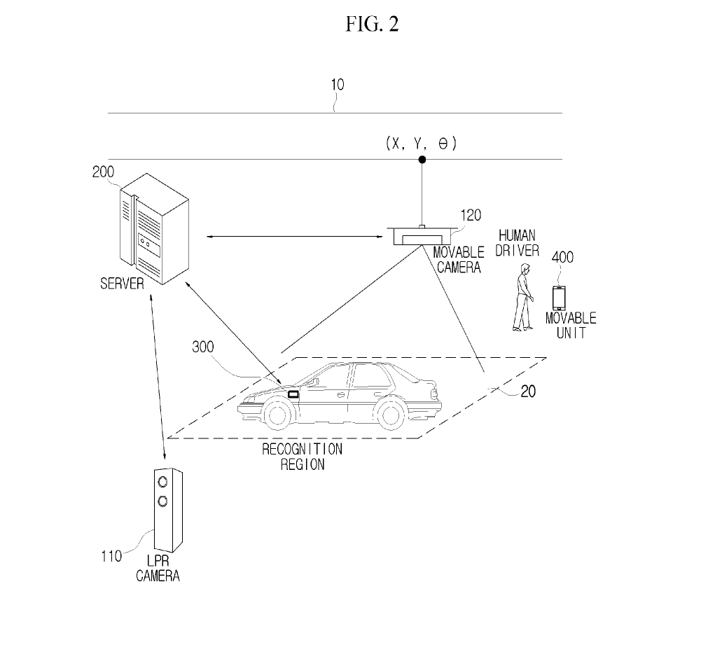

FIG. 2 is an exemplary diagram showing a remote autonomous driving system according to an embodiment of the present invention.

Referring to FIG. 2, the remote autonomous driving system according to an embodiment of the present invention includes a license plate recognition (LPR) camera 110 for recognizing a license plate of the vehicle, a camera 120 movably installed on the ceiling 10 of the indoor space, the server device 200, the vehicle control device 300, and the user terminal 400.

For example, when a vehicle is positioned at a place 20 for recognizing a license plate of a vehicle, the LPR camera 110 captures the license late of the vehicle. An image obtained by capturing the license plate of the vehicle is transmitted to the server device through a wired/wireless network. The server device 200 stores the image obtained by capturing the license plate of the vehicle and manages the stored image as unique information for identifying the vehicle.

The server device 200 registers the vehicle based on the unique information, and recognizes the unique information to perform remote control of the vehicle when the autonomous driving service is requested by the user of the vehicle.

The server device 200 transmits a control command for the movable camera 120 to track the vehicle to the movable camera 120, and the movable camera 120 captures the vehicle while tracking a trajectory of the vehicle according to the control command. The image information captured by the camera 120 and the position information of the camera 120 may be transmitted to the server device 200 through a wired/wireless network.

The server device 200 calculates a position and a pose of the vehicle based on the received image information and the position information of the camera 120 and maps the calculated position and pose on an indoor infrastructure map. In addition, the server device 200 designates a destination based on a current position of the vehicle, generates a driving route from the current position to the destination, and generates a driving control command corresponding to the driving route.

The driving control command is transmitted to the vehicle control device 300 included in the vehicle through a wireless network, and the vehicle control device 300 controls steering, driving, and braking of the vehicle based on the received driving control command.

In addition, the server device 200 transmits the information obtained by mapping the position and pose of the vehicle on the indoor infrastructure map to a user terminal 400 of a remotely controlled vehicle through a network.

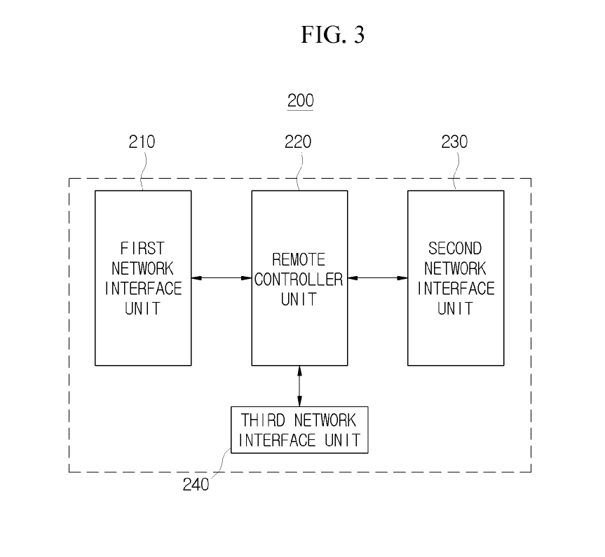

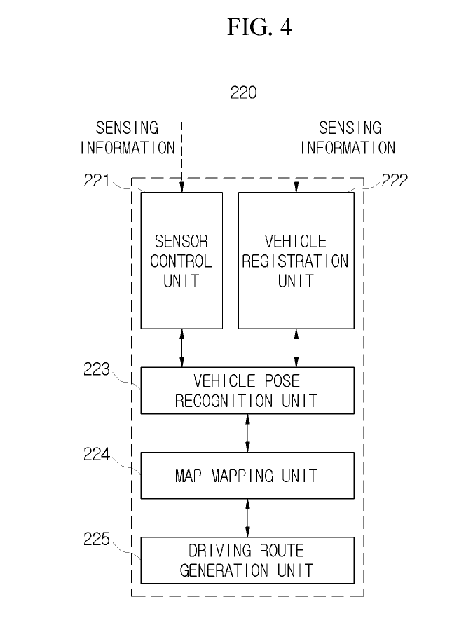

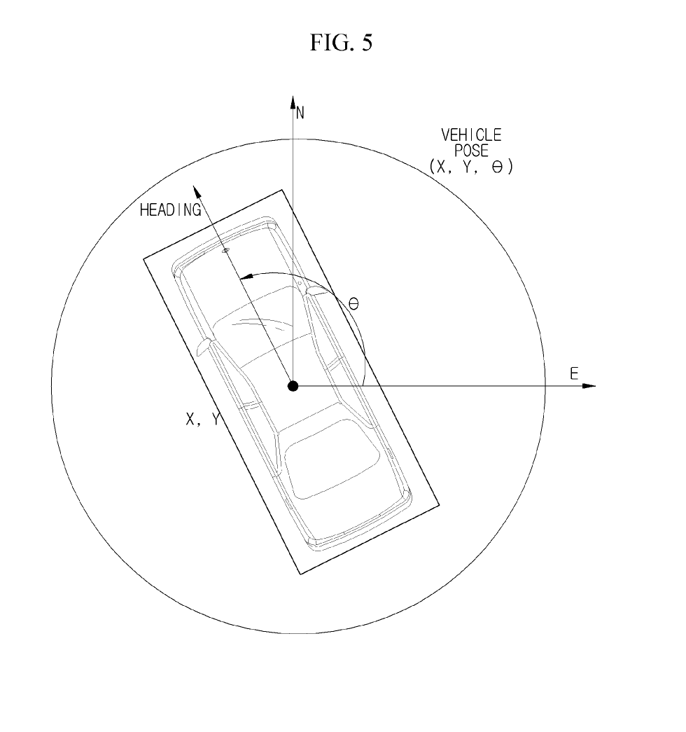

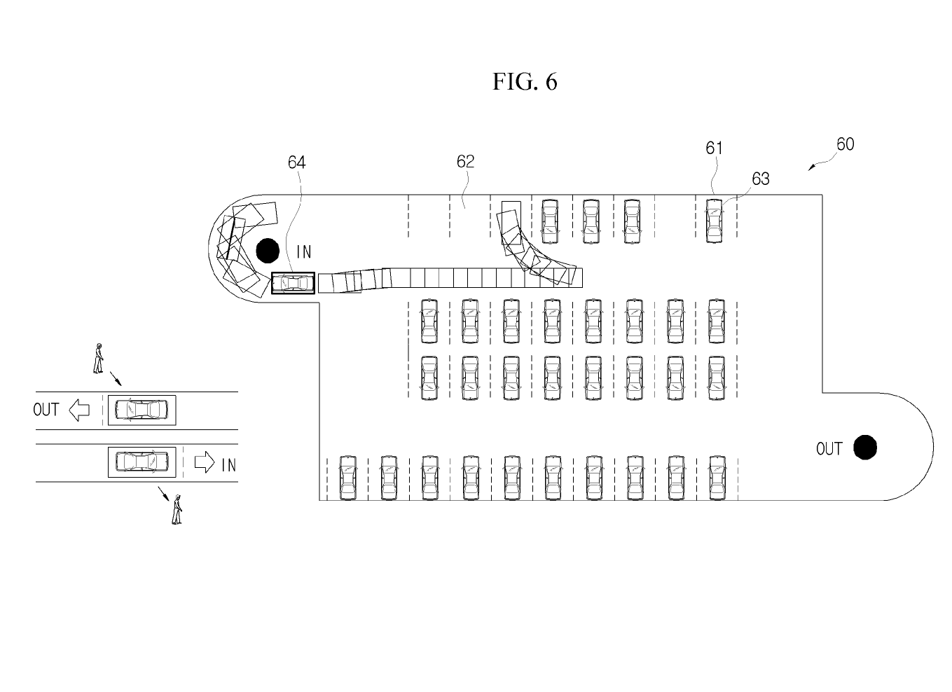

Referring to FIGS. 3 to 6, the configuration and function of the server device 200 according to an embodiment of the present invention will be described below. FIG. 3 is a block diagram showing a server device according to an embodiment of the present invention, FIG. 4 is a detailed block diagram showing a remote controller unit of FIG. 3, FIG. 5 is an exemplary diagram showing an example in which a position of an autonomous driving vehicle is recognized according to an embodiment of the present invention, and FIG. 6 is an exemplary diagram showing an example in which a position of an autonomous driving vehicle is mapped on an indoor infrastructure map according to an embodiment of the present invention.

Referring to FIG. 3, the server device 200 according to an embodiment of the present invention includes a first network interface unit 210 configured to receive sensing information obtained by a movable infrastructure sensor device sensing a remotely controlled vehicle and transmit a control command for the movable infrastructure sensor device to track the remotely controlled vehicle, a remote controller unit 220 configured to generate a driving route of the remotely controlled vehicle and a driving control command corresponding to the driving route using the sensing information, and a second network interface unit 230 configured to transmit the driving control command to the remotely controlled vehicle.

In addition, the server device 200 may further include a third network interface unit configured to transmit the information obtained by mapping the recognized position and pose of the vehicle on the indoor infrastructure map to a user terminal 400 and receive an autonomous driving service request from the user terminal 400.

Referring to FIG. 4, the remote controller unit 220 includes a sensor control unit 221, a vehicle registration unit 222, a vehicle pose recognition unit 223, a map mapping unit 224, and a driving route generation unit 225.

The sensor control unit 221 performs driving and control of the infrastructure sensor device 100. Specifically, the sensor control unit 221 generates a control command for the infrastructure sensor device 100 to track the remotely controlled vehicle and transmits the generated control command to the infrastructure sensor device 100 through the first network interface unit 210.

For example, when the sensor control unit 221 receives an autonomous driving service request from the user terminal 400 through the third network interface unit 240, the sensor control unit 221 searches the remotely controlled vehicle corresponding to the autonomous driving service request from the indoor infrastructure map. As a result, a relative position coordinate of the remotely controlled vehicle is searched from the indoor infrastructure map, and the sensor control unit 221 generates a control command for the infrastructure sensor device 100 to track the vehicle at the searched position coordinate.

When the sensing information obtained by the infrastructure sensor device 100 sensing the vehicle is received through the first network interface unit 210, the vehicle registration unit 222 stores and manages the received sensing information as unique information for identifying the vehicle. For example, the sensing information may be image information obtained by capturing the license plate of the vehicle.

The vehicle attitude recognition unit 223 calculates a position and a pose of the vehicle using the sensing information obtained by the infrastructure sensor device 100 sensing the vehicle. For example, the vehicle pose recognition unit 223 may calculate the position of the vehicle using the relative position coordinate of the infrastructure 100 included in the sensing information. In addition, the vehicle pose recognition unit 223 may calculate the pose of the vehicle using a rotation angle of the infrastructure sensor with respect to an axis which the infrastructure sensor is fixed to.

FIG. 5 shows an example in which the vehicle pose recognition unit 223 calculates the position and the pose of the vehicle using the sensing information received from the infrastructure sensor device 100.

As described above, the infrastructure sensor device 100 may be movably installed in an indoor space. Preferably, the infrastructure sensor device 100 physically moves along a predetermined route. The predetermined route has the relative position coordinate with respect to a specific position. When the infrastructure sensor device 100 is positioned at any point on the route, the relative position coordinate of the infrastructure sensor device 100 is automatically determined.

In addition, the infrastructure sensor device 100 moves in a physically fixed axis direction (N, E), as shown in FIG. 5. The infrastructure sensor device 100 rotates while tracking a heading direction of the vehicle. In this case, a rotation angle of the infrastructure sensor device 100 is automatically determined with respect to the fixed axis direction.

The relative position coordinate and rotation angle of the infrastructure sensor device 100 may be determined using the above-described method, and the vehicle pose recognition unit 223 recognizes the position and pose of the vehicle using the position coordinate and the rotation angle included in the sensing information received from the infrastructure sensor device 100.

The map mapping unit 224 updates the position and pose of the vehicle that are recognized by the vehicle pose recognition unit 223 on the indoor infrastructure map in real time. Here, the indoor infrastructure map may be previously stored in the server device 200 or received through a network.

FIG. 6 shows an example in which the position of the autonomous driving vehicle is mapped on the indoor infrastructure map. FIG. 6 illustrates an infrastructure map 60 of an indoor parking lot, where an individual parking partition is illustrated as a dot line. In the entire parking space, a space 61 that is occupied by a vehicle and a space 62 that is not occupied by a vehicle may be separately plotted. In the space 61 that is occupied by a vehicle, for example, a vehicle 63 is plotted on the space 61.

The position and pose of the remotely controlled vehicle are mapped on the indoor infrastructure map 60 from a start point to an end point and represented in the form of a rectangle 64. The indoor infrastructure map 60 and the information obtained by mapping the position and pose of the vehicle on the indoor infrastructure map 60 may be generated as image information. The image information is transmitted to the user terminal 400 through the third network interface unit 240.

The driving route generation unit 225 generates a driving route of the vehicle with reference to the indoor infrastructure map. Specifically, the driving route generation unit 225 designates a destination of the vehicle using the indoor infrastructure map, the recognized position and pose of the vehicle, and the information obtained by mapping the recognized position and pose of the vehicle on the indoor infrastructure map, and generates a driving route from the position of the vehicle that are recognized in real time to the destination.

In addition, the driving route generation unit 225 generates a driving control command corresponding to the generated driving route. For example, the driving route generation unit 225 generates the driving control command by adding additional information (for example, a speed limit, a driving lane, etc.) to the coordinate route point on the generated driving route, and transmits the generated driving control command to the vehicle through the second network interface unit 230.

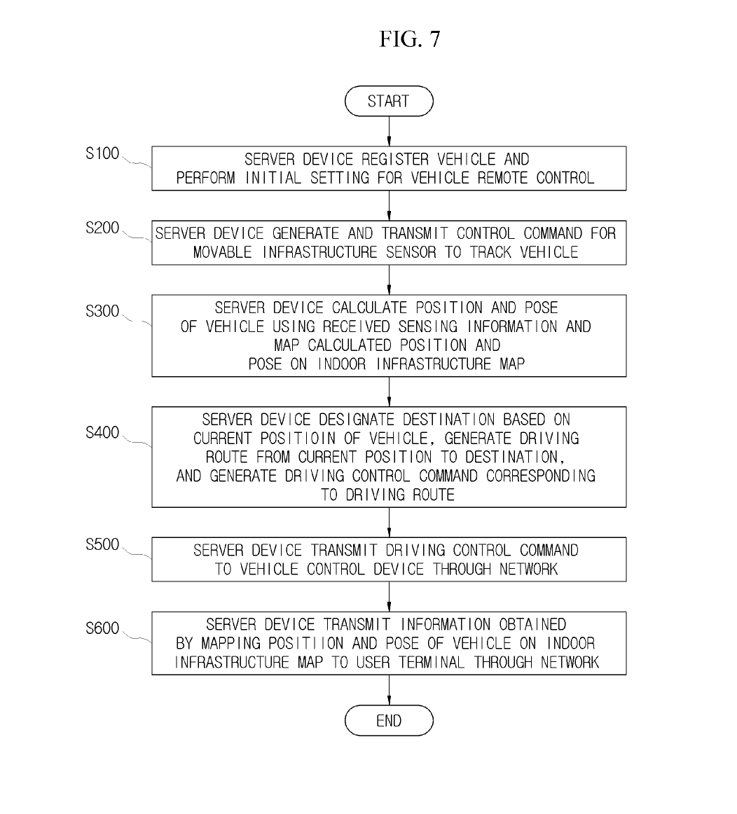

Referring to FIGS. 1 and 7, operations of a remote autonomous driving method based on position recognition performed by the server device according to an embodiment of the present invention will be described below. FIG. 7 is a flowchart showing operations of a remote autonomous driving system based on position recognition using an indoor infrastructure map and a sensor according to an embodiment of the present invention.

First, when a vehicle is positioned at a place for recognizing a license plate of the vehicle, the infrastructure sensor device 100 generates sensing information obtained by sensing the vehicle, and transmits the generated sensing information to the server device 200.

The server device 200 stores the received sensing information and manages the stored sensing information as unique information for identifying the vehicle. In addition, the server device 200 registers the vehicle based on the unique information, and recognizes the unique information to attempt remote control access to the vehicle when the autonomous driving service is requested by the user of the vehicle. When the remote control access to the vehicle is succeeded, a driving control right is transferred from a driver to the server device 200, and the autonomous driving service of the server device 200 is enabled in step S100.

Subsequently, the server device 200 generates a control command for the movable infrastructure sensor device 100 to track the vehicle and transmits the generated control command to the infrastructure sensor device 100 in step S200.

As described above, the infrastructure sensor device 100 may be designed to be installed on a ceiling of a space such as an underground parking lot of a department store to move freely or designed to move along a route on which a vehicle may be driven.

In this case, the server device 200 moves the infrastructure sensor device 100 to a point at which the autonomous driving service starts, and generates a control command for tracking the vehicle from a start point of the autonomous driving service. Here, the start point of the autonomous driving service may be previously determined.

Furthermore, the autonomous driving service may be requested in order to move a parked vehicle to a certain point in a space such as an underground parking lot of a department store. In this case, the server device 200 searches the remotely controlled vehicle for which the autonomous driving service is requested from the indoor infrastructure map. As a result, a relative position coordinate of the remotely controlled vehicle is searched from the indoor infrastructure map, and the server device 200 generates a control command for the infrastructure sensor device 100 to track the vehicle at the searched position coordinate.

According to the control command, the infrastructure sensor device 100 tracks and senses the vehicle to generate sensing information and then transmits the sensing information to the server device 200.

The server device 200 calculates a position and a pose of the vehicle based on the received sensing information and maps the calculated position and pose on an indoor infrastructure map in step S300.

In addition, the server device 200 designates a destination based on a current position of the vehicle, generates a driving route from the current position to the destination, and generates a driving control command corresponding to the driving route in step S400.

Subsequently, the server device 200 transmits the generated driving control command to the vehicle control device 300 included in the vehicle through a wireless network in step S500, and the vehicle control device 300 controls steering, driving, and braking of the vehicle based on the received driving control command.

When a request for the vehicle information is received from the user terminal 400, the server device 200 transmits the information obtained by mapping the position and pose of the vehicle on the indoor infrastructure map to a user terminal 400 through the wireless network in step S600. In this case, the information obtained by mapping the position and pose of the vehicle on the indoor infrastructure map may be generated as image information that may be visually displayed.

According to an embodiment of the present invention, it is possible to accurately recognize a position and an attitude of the autonomous driving vehicle using an indoor infrastructure map and a sensor and effectively perform autonomous driving based on the recognized position and attitude.

Accordingly, the remote autonomous driving system according to an embodiment of the present invention may be applied to a large-scale store, a department store, and an airport where an indoor infrastructure can be established.

It will be understood by those skilled in the art that various changes in form and details may be made therein without departing from the spirit and scope of the invention as defined by the appended claims. The above embodiments are accordingly to be regarded as illustrative rather than restrictive. Therefore, the scope of the invention is defined not by the detailed description of the invention but by the appended claims, and a variety of embodiments within the scope will be construed as being included in the present invention.

What is claimed is:

1. A server device for remote autonomous driving based on position recognition, the server device comprising:
a first network interface unit configured to receive sensing information obtained by a movable infrastructure sensor device sensing a remotely controlled vehicle and transmit a control command for the movable infrastructure sensor device to track the remotely controlled vehicle;
a remote controller unit configured to generate a driving route of the remotely controlled vehicle and a driving control command corresponding to the driving route using the sensing information; and
a second network interface unit configured to transmit the driving control command to the remotely controlled vehicle.

2. The server device of claim 1, wherein the remote controller unit comprises a vehicle pose recognition unit configured to recognize a pose of the remotely controlled vehicle using the sensing information.

3. The server device of claim 2, wherein the vehicle pose recognition unit recognizes the position of the remotely controlled vehicle using a relative position coordinate of the infrastructure sensor device included in the sensing information.

4. The server device of claim 2, wherein the vehicle pose recognition unit recognizes the pose of the remotely controlled vehicle using a rotation angle of the infrastructure sensor with respect to an axis which the infrastructure sensor is fixed to.

5. The server device of claim 2, wherein the remote controller further comprises a map mapping unit configured to map the recognized position and pose of the vehicle on an indoor infrastructure map.

6. The server device of claim 5, wherein the remote controller further comprises a driving route generation unit configured to designate a destination of the remotely controlled vehicle using the indoor infrastructure map, the recognized position and pose information of the vehicle, and information obtained by mapping the recognized position and pose information of the vehicle on the indoor infrastructure map, and generate a driving route from a real-time recognized position of the vehicle to the destination.

7. The server device of claim 1, wherein the driving control command includes additional information including a vehicle speed and a driving lane in an entire route from departure to destination.

8. The server device of claim 1, further comprising a third network interface unit configured to transmit the information obtained by mapping the recognized position and pose information of the vehicle on the indoor infrastructure map to a user terminal and receive an autonomous driving service request from the user terminal.

9. The server device of claim 8, wherein the remote controller searches the remotely controlled vehicle corresponding to the autonomous driving service request from the indoor infrastructure map and transmits a control command for the infrastructure sensor device to track the searched remotely controlled vehicle through the first network interface unit.

10. A remote autonomous driving method that is performed by a server device for remote autonomous driving based on position recognition, the method comprising:
registering a remotely controlled vehicle using sensing information obtained by sensing the remotely controlled vehicle;
generating a control command for a movable infrastructure sensor device to track the remotely controlled vehicle; and
generating a driving route of the remotely controlled vehicle and a driving control command corresponding to the driving route using the sensing information obtained by the infrastructure sensor device tracking and sensing the remotely controlled vehicle.

11. The method of claim 10, wherein the generating of a driving route of the remotely controlled vehicle and a driving control command corresponding to the driving route comprises:
recognizing the position and pose of the remotely controlled vehicle using the sensing information obtained by the infrastructure sensor device tracking and sensing the remotely controlled vehicle; and
mapping the recognized position and pose of the vehicle on an indoor infrastructure map.

12. The method of claim 11, wherein the recognizing of the position and pose of the remotely controlled vehicle comprises:
recognizing the position of the remotely controlled vehicle using a relative position coordinate of the infrastructure sensor device included in the sensing information; and
recognizing the pose of the remotely controlled vehicle using a rotation angle of the infrastructure sensor with respect to an axis which the infrastructure sensor is fixed to.

13. The method of claim 11, wherein the generating of a driving route of the remotely controlled vehicle and a driving control command corresponding to the driving route further comprises:
designating a destination of the remotely controlled vehicle using the indoor infrastructure map, the recognized position and pose information of the vehicle, and information obtained by mapping the recognized position and pose information of the vehicle on the indoor infrastructure map; and
generating a driving route from a real-time recognized position of the vehicle to the destination.

14. The method of claim 10, wherein the driving control command includes additional information including a vehicle speed and a driving lane in an entire route from departure to destination.

15. The method of claim 10, further comprising:
transmitting the information obtained by mapping the recognized position and pose information of the vehicle on the indoor infrastructure map to a user terminal; and
receiving an autonomous driving service request from the user terminal.

16. The method of claim 15, wherein the receiving of an autonomous driving service request comprises:
searching the remotely controlled vehicle corresponding to the autonomous driving service request from the indoor infrastructure map; and
generating a control command for the infrastructure sensor device to track the searched remotely controlled vehicle.
